(19) United States
(12) Patent Application Publication
(10) Pub. No.: US 2012/0161660 A1
(43) Pub. Date: Jun. 28, 2012

(54) Driving Integrated Circuit and Display Apparatus Including the Same

(76) Inventor: Soong-Yong Joo, Yongin-city (KR)

(21) Appl. No.: 13/282,412

(22) Filed: Oct. 26, 2011

(30) Foreign Application Priority Data
Dec. 23, 2010 (KR) 10-2010-0133721

(51) Int. Cl. H05B 37/02

(52) U.S. Cl. 315/240

(57) ABSTRACT

A driving integrated circuit (driving IC) connected to a display panel by a chip on glass (COG) method includes a pair of bumps electrically coupled to a test pad of the display panel; a power source electrically coupled to a first bump of the pair of bumps; a circuit device electrically coupled between a ground terminal and a second bump of the pair of bumps; and a node measuring unit for measuring a voltage at a node between the second bump and the circuit device.

### CROSS-REFERENCE TO RELATED PATENT APPLICATION

This application claims priority to and the benefit of Korean Patent Application No. 10-2010-0133721, filed on Dec. 23, 2010, in the Korean Intellectual Property Office, the disclosure of which is incorporated herein in its entirety by reference.

### BACKGROUND

1. Field

Embodiments of the present invention relate to a display apparatus.

2. Description of the Related Art

Generally, a display apparatus including a liquid crystal display device, an organic light emitting device or an inorganic light emitting device is formed of a display panel and a driving device so as realize an image on a flat substrate.

The display panel may be divided into a display part and a non-display part. The display part has a plurality of pixels defined by a plurality of gate lines and a plurality of data lines which cross each other. The non-display part that is an outer portion of the display part has data pads and gate pads that are respectively formed at ends of the gate lines and the data lines, and interfaces with an electrical signal supplied from an external driving device.

The driving device includes a chip mounted on a substrate configured to drive the display panel, e.g., the driving device includes a driving integrated circuit (driving IC) and a flexible printed circuit (FPC).

The driving IC may be mounted on the display panel using a chip on glass (COG) method, a tape carrier package (TCP) method or a chip on film (COF) method. Compared to the TCP method and the COF method, the COG method is simple and may increase the relative size of the display part in the display panel so that, recently, the COG method is widely used.

When the COG method is performed, connection resistance (hereinafter, referred to as COG resistance) is incurred at the connection between the display panel and the driving IC. When the COG resistance is increased due to a COG process variation, an IC bump shape, a pad resistance variation or the like, functions of the display apparatus may deteriorate. Thus, it is desirable to measure the COG resistance.

FIG. 1 is a schematic block diagram illustrating a method of measuring a COG resistance by using a test point formed in an FPC 2 according to the related art.

FIG. 1 illustrates a test pattern 6 formed in the test point so as to measure the COG resistance due to connection between a display panel 3 and a FPC 2 (refer to DATA IC) that is a data driver.

In order to measure the COG resistance due to the connection between the display panel 3 and the FPC 2, line paths 7 are formed on the FPC 2 so as to measure a resistance of a connection part 5 of a data IC 9, and measurement terminals 8 are arranged at ends of the line paths 7 so as to connect the ends to measuring equipment 1.

However, when the test pattern 6 is formed on the FPC 2 and the display panel 3 so as to measure the COG resistance, the test pattern 6 and the number of measurement points are limited due to other signal lines or a limited mounting area. Also, in a liquid crystal display device, after a liquid crystal panel module is assembled, the FPC 2 is detached from a backlight unit (BLU) before measuring the COG resistance at a measurement point, which may cause damage to the product.

### SUMMARY

Embodiments of the present invention are directed to a circuit configuration in which connection resistance between a display panel and a driving device can be automatically measured.

Embodiments of the present invention provide a chip on glass (COG) resistance measuring circuit capable of automatically measuring and monitoring a COG resistance.

According to an aspect of an embodiment of the present invention, there is provided a driving integrated circuit (driving IC) connected to a display panel by a chip on glass (COG) method, the driving IC including a pair of bumps electrically coupled to a test pad of the display panel; a power source electrically coupled to a first bump of the pair of bumps; a circuit device electrically coupled between a ground terminal and a second bump of the pair of bumps; and a node measuring unit for measuring a voltage at a node between the second bump and the circuit device.

The circuit device may include a resistor, and the node measuring unit may include an analog-to-digital (ND) converter for measuring the voltage at the node and for converting the voltage into a digital value.

The circuit device may include a capacitor, and the node measuring unit may include a comparison unit for comparing the voltage at the node with a target voltage; and a counter for counting a time elapsed for the voltage at the node to reach the target voltage.

The driving IC may further include a register for storing the voltage.

The power source may be electrically coupled to the first bump via a switch, and may be an internal voltage of the driving IC.

The driving IC may further include a first switch electrically coupled between the power source and the first bump, and a second switch electrically coupled between the second bump and the circuit device, wherein the first switch and the second switch are configured to time-divisionally electrically connect one or more pairs of bumps to one or more respective test pads.

According to another embodiment of the present invention, there is provided a display apparatus including a display panel including a test pad; and a driving integrated circuit (driving IC) connected to the display panel by a chip on glass (COG) method, configured to automatically measure a connection resistance due to the COG connection, and comprising a pair of bumps electrically coupled to the test pad, a power source electrically coupled to a first bump of the pair of bumps, a circuit device electrically coupled between a ground terminal and a second bump of the pair of bumps, and a node measuring unit for measuring a voltage at a node between the second bump and the circuit device.

The circuit device may include a resistor, and the node measuring unit may include an analog-to-digital (A/D) converter for measuring the voltage at the node and for converting the voltage into a digital value.

The circuit device may include a capacitor, and the node measuring unit may include a comparison unit for comparing the voltage at the node with a target voltage; and a counter for counting a time elapsed for the voltage at the node to reach the target voltage.

The driving IC may further include a register for storing the voltage.

The power source may be electrically coupled to the first bump via a switch, and may be an internal voltage of the driving IC.

The circuit device may be arranged in the driving IC or may be arranged on the display panel outside the driving IC.

The driving IC may further include a first switch arranged between the power source and the first bump, and a second switch arranged between the second bump and the circuit device, wherein the first switch and the second switch are configured to time-divisionally electrically connect one or more pairs of bumps to one or more respective test pads.

### BRIEF DESCRIPTION OF THE DRAWINGS

The above and other features and advantages of embodiments of the present invention will become more apparent by describing in detail exemplary embodiments thereof with reference to the attached drawings in which:

FIG. 1 is a schematic block diagram illustrating a method of measuring a chip on glass (COG) resistance by using a test point formed in a flexible printed circuit (FPC) according to the related art;

FIG. 2 is a diagram of a display apparatus according to an embodiment of the present invention;

FIG. 3 is a cross-sectional view of the display apparatus in which a driving integrated circuit (IC) is mounted by performing a COG method according to an embodiment of the present invention;

FIG. 4 is a plan view of the display apparatus, magnifying a portion of the driving IC in which signal pads are formed according to an embodiment of the present invention;

FIG. 5 is a bottom view of the driving IC having a bump structure according to an embodiment of the present invention;

FIG. 6 is a cross-sectional view of a case in which a pad region of FIG. 4 and the driving IC are coupled by performing a COG method according to an embodiment of the present invention;

FIG. 7 is a diagram describing a method of measuring a COG resistance, according to an embodiment of the present invention;

FIGS. 8 through 11 illustrate a circuit configuration of a COG resistance measuring unit in a driving IC, according to an embodiment of the present invention;

FIG. 12 is a graph showing a delay of a voltage at a measurement node according to a COG resistance according to an embodiment of the present invention; and

FIG. 13 is a diagram of a COG resistance automatic measurement system, according to an embodiment of the present invention.

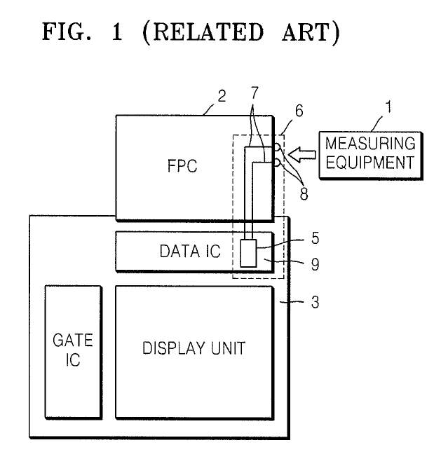

### DETAILED DESCRIPTION

Hereinafter, the present invention will be described in detail by explaining exemplary embodiments of the invention with reference to the attached drawings. Like reference numerals in the drawings denote like elements. In the following description, well-known functions or constructions are not described in detail since they would obscure the invention with unnecessary detail.

As used herein, the term “and/or” includes any and all combinations of one or more of the associated listed items.

While terms “first” and “second” are used to describe various components, parts, regions, layers and/or portions, the components, parts, regions, layers and/or portions are not limited to the terms “first” and “second”. The terms “first” and “second” are used only to distinguish between each of components, each of parts, each of regions, each of layers and/or each of portions. Thus, throughout the specification, a first component, a first part, a first region, a first layer or a first portion may indicate a second component, a second part, a second region, a second layer or a second portion without conflicting with the present invention.

Furthermore, all examples and conditional language recited herein are to be construed as being without limitation to such specifically recited examples and conditions. Throughout the specification, a singular form may include plural forms, unless there is a particular description contrary thereto. Also, terms such as “comprise” or “comprising” are used to specify existence of a recited form, a number, a process, an operations, a component, and/or groups thereof, not excluding the existence of one or more other recited forms, one or more other numbers, one or more other processes, one or more other operations, one or more other components and/or groups thereof.

Unless expressly described otherwise, all terms including descriptive or technical terms which are used herein should be construed as having meanings that are obvious to one of ordinary skill in the art.

Also, terms that are defined in a general dictionary and that are used in the following description should be construed as having meanings that are equivalent to meanings used in the related description, and unless expressly described otherwise herein, the terms should not be construed as being ideal or excessively formal.

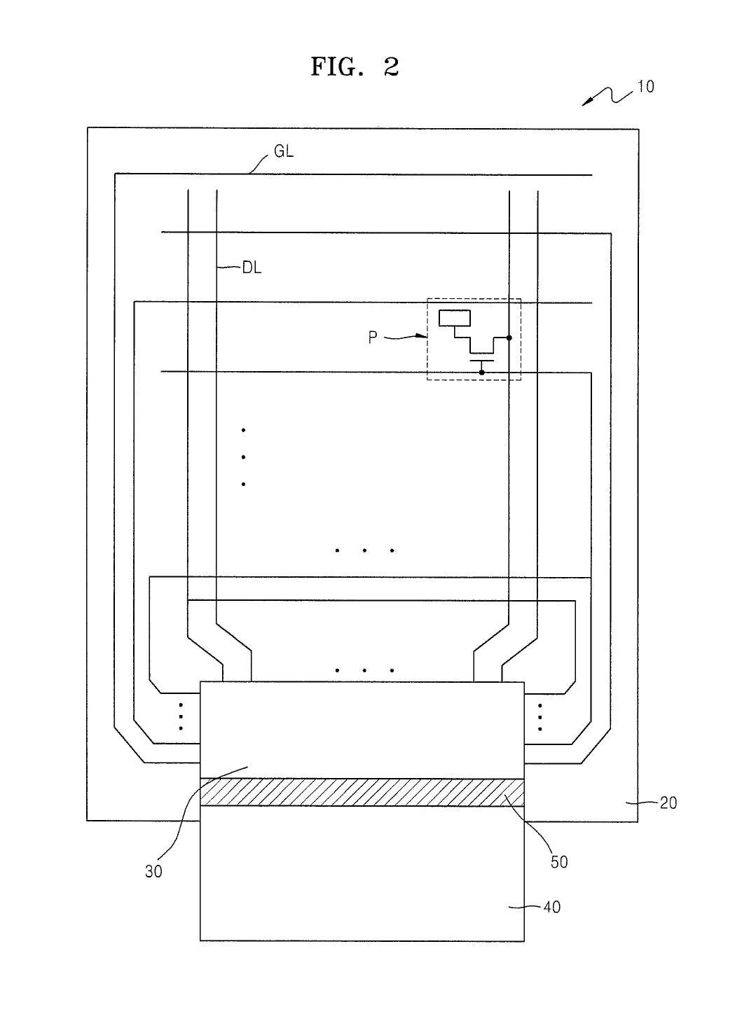

FIG. 2 is a diagram of a display apparatus 10 in plan view according to an embodiment of the present invention.

Referring to FIG. 2, according to one embodiment of the present invention, the display apparatus 10 includes a liquid crystal display device, an organic light emitting device or an inorganic light emitting device, and realizes an image on a flat substrate. The display apparatus 10 is formed of a display panel 20 and a driving device. The driving device includes a chip mounted on a substrate so as to drive the display panel, e.g., the driving device includes a driving integrated circuit (driving IC), a flexible printed circuit (FPC) or the like.

The display apparatus 10 may include a display panel 20, a driving IC 30 applying a driving signal to each of gate lines GL and data lines DL formed on the display panel 20, a FPC 40 transmitting data (e.g., predetermined data) and a control signal to the driving IC 30, and a connection pad 50 connecting the driving IC 30 with the FPC 40.

The gate lines GL are separated from each other at regular horizontal intervals and the data lines DL are separated from each other at regular vertical intervals and crossing the gate lines GL are formed on the display panel 20. Also, pixels P are formed on the display panel 20 at crossing regions of the gate lines GL and the data lines DL. Each of the pixels P includes a thin film transistor T having a gate electrode, an active layer, a source electrode and a drain electrode.

A gate pad is formed at an end of each gate line GL so as to deliver a scan signal from the driving IC 30 to each gate line GL. Also, a data pad is formed at an end of each data line DL so as to deliver a data signal from the driving IC 30 to each data line DL.

The driving IC 30 in the form of an IC chip is mounted on the display panel 20. The driving IC 30 generates a scan signal and a data signal in response to (or in accordance with) a driving power and signals received from an external source via the connection pad 50, and provides the scan signal and the data signal to the gate lines GL and the data lines DL, respectively. For this operation, the driving IC 30 may include at least one scan driver for generating the scan signal and at least one data driver for generating the data signal.

The FPC 40 receives a driving signal from an external driving circuit. Upon the receipt of the driving signal, the FPC 40 generates various controls signals in response to (or in accordance with) the received driving signal, and drives the pixels P and/or the driving IC 30 accordingly.

In order to connect signal pads (e.g., the gate pad and the data pad) to the driving IC 30, bumps are formed on the driving IC 30 which are to be connected to the signal pads.

The driving IC 30 having the bumps formed thereon is connected to the signal pads by performing a chip on glass (COG) method. The COG method involves adhering the driving IC 30 to an insulating substrate by using the bumps of driving IC 30 and an Anisotropic Conductive Film (ACF).

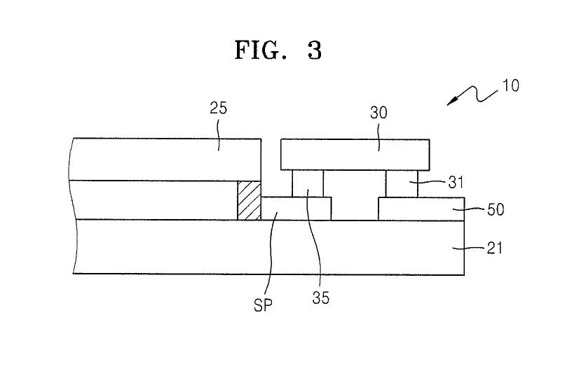

FIG. 3 is a cross-sectional view of a portion of the display apparatus 10 in which the driving IC 30 is mounted by performing the COG method according to one embodiment of the present invention.

Referring to FIGS. 2 and 3, the driving IC 30 is mounted on an end (or at an edge) of the display panel 20 formed by adhering a first substrate 21 and a second substrate 25, that is, the driving IC 30 is mounted on a portion of the first substrate 21 in which a signal pad SP (e.g., a gate pad or a data pad) is formed.

An input bump 31 that is formed on a bottom surface of the driving IC 30 is connected to the FPC 40 via the connection pad 50 and receives a signal from the FPC 40. An output bump 35 that is formed on the bottom surface of the driving IC 30 is connected to the signal pad SP and outputs a scan signal and a data signal, which are generated by the driving IC 30, to the gate lines GL and the data lines DL via the signal pad SP.

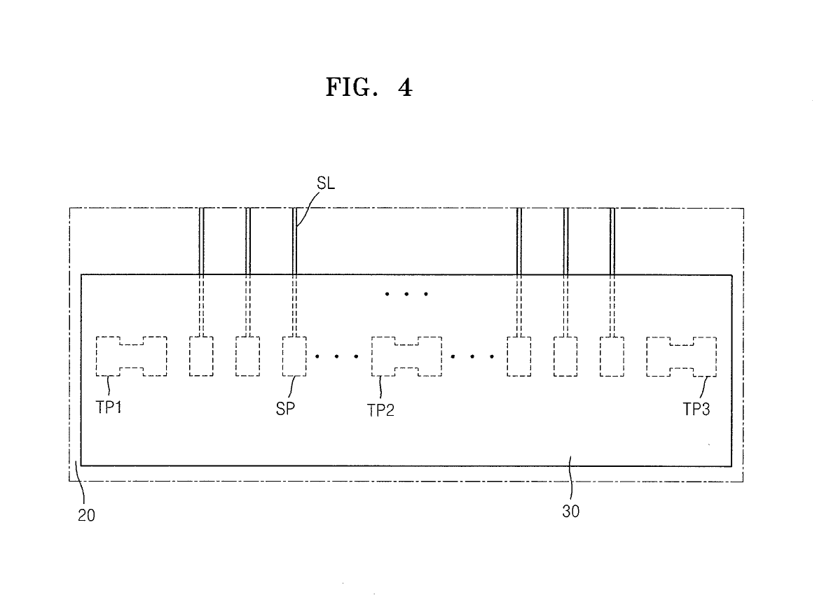

FIG. 4 is a plan view of a portion of the display apparatus 10, magnifying a portion of the driving IC 30 in which signal pads SP are formed.

Referring to FIGS. 2 and 4, a plurality of signal lines SL that are separate from each other in a first direction are arranged on the display panel 20 of the display apparatus 10. The signal lines SL are gate lines GL or data lines DL.

A driving signal output from the driving IC 30 is applied to pixels of the display panel 20 via the signal lines SL that are connected to respective ones of the signal pads SP. The signal pads SP are connected to the driving IC 30 by using an ACF, and correspond to respective bumps of the driving IC 30. The ACF may function to adhere the signal pads SP to the driving IC 30, may cover an entire portion of the signal pads SP and the driving IC 30, and may be formed to be larger than a size of the driving IC 30.

In addition to the signal pads SP, a plurality of test pads TP are arranged at a plurality of test points on the display panel 20 so as to measure a COG resistance. While FIG. 3 illustrates three test points, that is, three test pads that are a test pad TP1, a test pad TP2, and a test pad TP3 positioned at a center, left, and right points, embodiments of the present invention are not limited thereto, and thus may include one or more test pads arranged at positions (e.g., predetermined positions) by setting a plurality of test points.

The signal pads SP are electrically connected to the signal lines SL including the gate lines GL and the data lines DL and deliver the control signal from the driving IC 30 to the signal lines SL. However, the test pad TP is not for driving the display panel 20, so that the test pad TP is not connected to the gate lines GL or the data lines DL. In one embodiment of the present invention, a dummy gate line GL or a dummy data line DL is formed on the display panel 20, and then the test pad TP is connected to the dummy gate line GL or the dummy data line DL. Also, in another embodiment of the present invention, the test pad TP is connected to a signal line SL of the display panel 20, and a switch may be arranged at the signal line SL connected to the test pad TP.

The test pad TP may be formed of two pads, that is, the test pad TP may be formed as a pair. The test pad TP may be formed such that a connection part for creating a short-circuit between the two pads is H-shaped, or the two pads are integrally formed and have a rectangular shape. The test pad TP is formed using the same process as the signal pads SP.

The signal pads SP and the test pad TP are formed of a conductive material, e.g., the signal pads SP and the test pad TP may be formed as transparent electrodes using a material such as Indium Tin Oxide (ITO).

FIG. 5 is a bottom plan view of the driving IC 30 having a bump structure according to another embodiment of the present invention.

Referring to FIGS. 2 through 5, a plurality of bumps corresponding to signal pads SP and test pads TP are formed on a bottom surface of the driving IC 30. Each bump may be formed of a conductive material including gold (Au), copper (Cu), nickel (Ni) or similar conductive materials, but is not limited thereto. The driving IC 30 includes an input bump (or a plurality of input bumps) 31 and an output bump (or a plurality of output bumps) 35.

The input bump 31 is connected to the FPC 40 via the connection pad 50 and receives a signal from the FPC 40.

The output bumps 35 are connected to each of the signal pads SP and output a scan signal and a data signal, which are generated by the driving IC 30, to each gate line GL and each data line DL via the signal pads SP.

The output bumps 35 include bumps connected to a test pad TP that are independent from the signal pad SP. Here, two bumps form a pair so as to correspond to the test pad TP formed as a pair. FIG. 5 illustrate output bumps 35a, 35b, and 35c corresponding to the test pads TP1, TP2 and TP3 of FIG. 4, respectively.

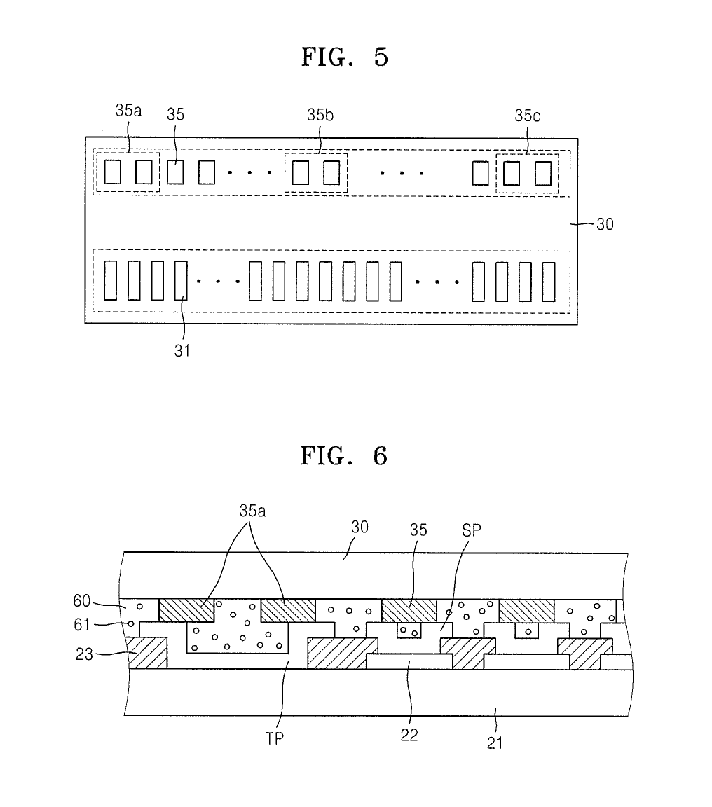

FIG. 6 is a cross-sectional view of a pad region of FIG. 4 and the driving IC 30 of FIG. 5 that are coupled by performing a COG method.

Referring to FIG. 6, in the pad region of the display panel 20, terminals 22 formed as a metal layer are arranged on a first substrate 21, and insulating layers 23 are formed on the terminals 22. Also, transparent conductive layers (e.g., an ITO layer) are formed on the insulating layers 23. The transparent conductive layers become signal pads SP or test pads TP. For example, the terminals 22 may be gate lines GL or data lines DL. Here, a portion of the insulating layers 23 is removed so as to allow the terminals 22 to be mutually and electrically connected to the driving IC 30, and the transparent conductive layers contact the exposed terminals 22. In one embodiment of the present invention, terminals 22 are not formed in area in which the test pads TP are to be formed.

An ACF 60 that is an adhering resin containing a plurality of conductive particles 61 is coated between bumps 35 and 35a of the driving IC 30 and the transparent conductive layers, and then the bumps 35 and 35a and the transparent conductive layers are pressed and connected to each other so that the bumps 35 and 35a and the transparent conductive layers are electrically connected to each other.

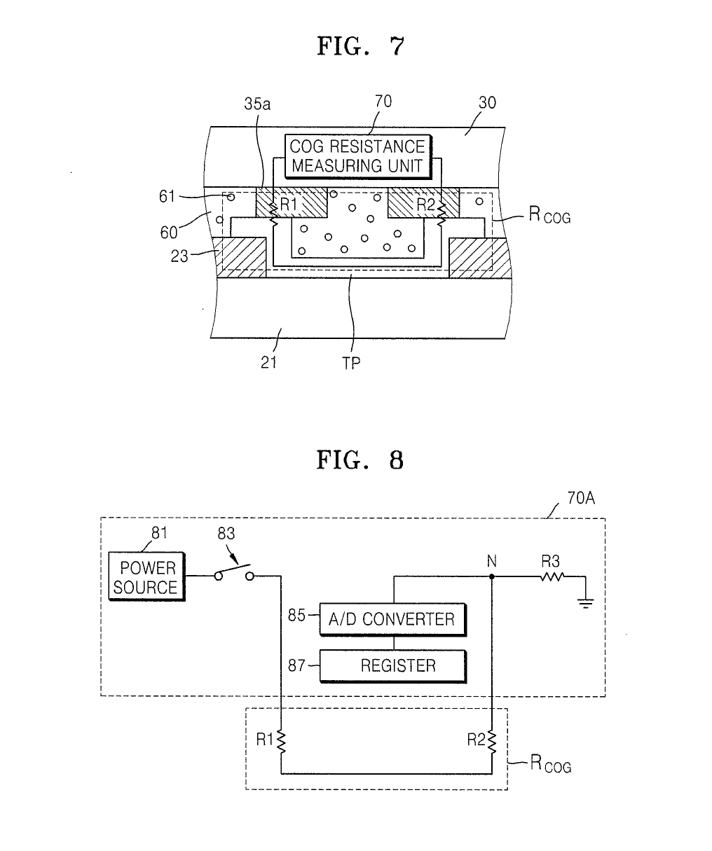

FIG. 7 is a diagram describing a method of measuring a COG resistance according to an embodiment of the present invention.

Referring to FIG. 7, a COG resistance R_{COG} exists due to connection between output bumps 35a of a driving IC 30 and a signal pad SP on a first substrate 21 of a display panel 20. In order to measure the COG resistance R_{COG}, a test pad TP is formed on the first substrate 21, and the COG resistance R_{COG} is measured by connecting the test pad TP and a pair of the output bumps 35a corresponding to the test pad TP of the driving IC 30.

The COG resistance R_{COG} includes a first resistor R1 and a second resistor R2 that are formed in two connection parts in which the test pad TP and a pair of the output bumps 35a are connected to each other. The first resistor R1 and the second resistor R2, which are the COG resistance R_{COG}, may be connected in series by the test pad TP contacting the first substrate 21.

The driving IC 30 has a COG resistance measuring unit 70 that includes a circuit which forms a current path flowing through the first resistor R1 and the second resistor R2 that are formed in the two connection parts, so that the COG resistance measuring unit 70 automatically measures the COG resistance R_{COG}. A configuration of the COG resistance measuring unit 70 according to one embodiment of the present invention will now be described in more detail.

FIG. 8 illustrates a circuit configuration of a COG resistance measuring unit 70A in a driving IC, according to an embodiment of the present invention.

Referring to FIG. 8, the COG resistance measuring unit 70A measures a first resistor R1 and a second resistor R2 that are included in a COG resistance R_{COG} formed due to a connection between a test pad of the display panel 20 and a pair of bumps. The COG resistance measuring unit 70A includes a power source 81, a switch 83, an analog-to-digital (A/D) converter 85, a register 87, and a third resistor R3.

The power source 81 is connected to a first bump of the pair of bumps, so that the power source 81 is connected in series with the first resistor R1 that is formed by connection between the first bump and the test pad. The second resistor R2 that is connected in series with the first resistor R1 is formed when a second bump of the pair of bumps is connected with the test pad. The power source 81 provides a power voltage V_{IC}, thereby allowing a current to flow through the first resistor R1 and the second resistor R2. The power source 81 may be an internal power source (or internal voltage) of the driving IC.

The switch 83 selectively connects and disconnects the power source 81 to and from the first bump.

The A/D converter 85 measures a voltage V_{N} at a measurement node N that is a node between the second resistor R2 and the third resistor R3, and converts the voltage V_{N} into a digital voltage value. The voltage V_{N} at the measurement node N varies according to the COG resistance R_{COG}.

The register 87 stores the digital voltage value at the measurement node N which is received from the A/D converter 85. According to one embodiment of the present invention, stored digital voltage value is read by an external controller via an IC interface and is displayed on a monitor. The IC interface may include a central processing unit (CPU) interface, a serial interface or the like.

One end of the third resistor R3 is connected to the second bump and the other end is connected to a ground terminal. The third resistor R3 is connected to the second bump so that the third resistor R3 is serially connected to the first resistor R1 and the second resistor R2 that are part of the COG resistance R_{COG}. The third resistor R3 may be formed in the driving IC, or the third resistor R3 may be formed on the display panel 20 outside the driving IC.

The COG resistance R_{COG} may be calculated in accordance with Equation 2 by solving Equation 1 after obtaining the voltage V_{N} at the measurement node N. Here, the power voltage V_{IC} and the third resistor R3 are constant (or known) values, and the values of the first resistor R1 and the second resistor R2 are assumed to be the same.

$$\begin{matrix}{V}_{N} = {V}_{IC} \times \frac{R 3}{( R 1 + R 2 ) + R 3} & Equation 1 \\ {R}_{COG} = R 1 + R 2 , ( R 1 = R 2 ) & Equation 2\end{matrix}$$

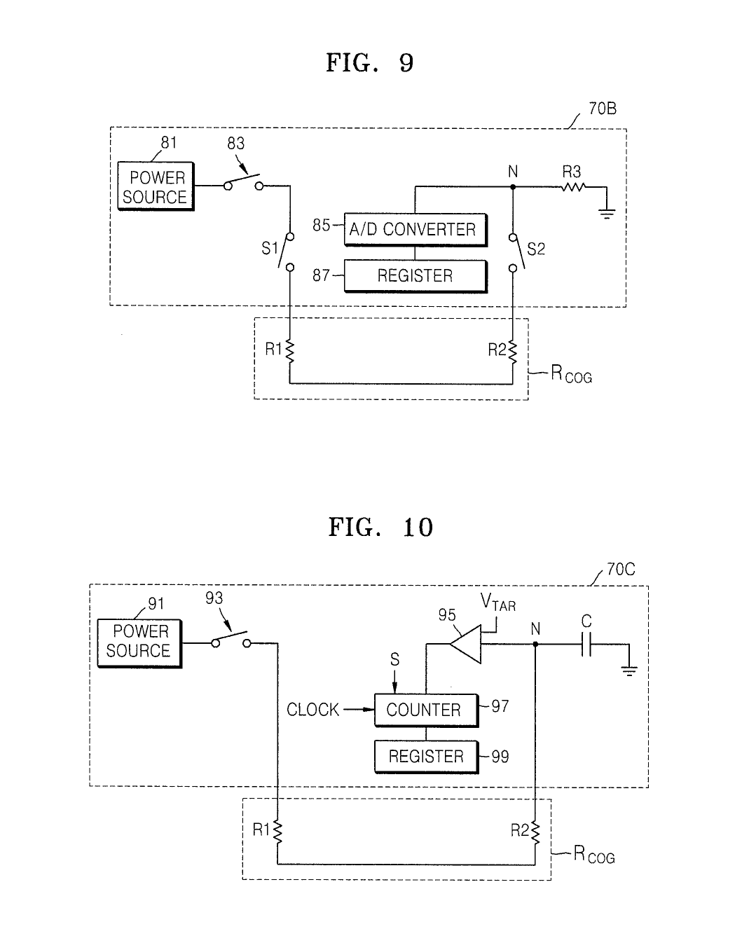

FIG. 9 illustrates a circuit configuration of a COG resistance measuring unit 70A in a driving IC, according to another embodiment of the present invention.

The embodiment of FIG. 9 is different from the embodiment of FIG. 8 in that a first switch S1 is arranged between a power source 81 and a first resistor R1, and a second switch S2 is arranged between a second resistor R2 and a third resistor R3. Except for these differences, other components of the embodiment of FIG. 9 are the same as those of the embodiment of FIG. 8, thus, detailed descriptions thereof are omitted here.

In the embodiment of FIG. 8, the COG resistance measuring unit 70A is arranged in the driving IC at every test point. However, in the embodiment of FIG. 9, only one COG resistance measuring unit 70B is arranged in the driving IC. That is, the COG resistance measuring unit 70B of FIG. 9 may time-divisionally measure COG resistances R_{COG} at a plurality of test points by using the first switch S1 and the second switch S2 (e.g., a plurality of first switches S1 and a plurality of second switches S2 arranged to selectively couple a pair of bumps and test pads to the COG resistance measuring unit 70B).

FIG. 10 illustrates a circuit configuration of a COG resistance measuring unit 70C in a driving IC, according to another embodiment of the present invention.

Referring to FIG. 10, a COG resistance measuring unit 70C measures resistance values of a first resistor R1 and a second resistor R2 included in a COG resistance R_{COG} formed by a pair of bumps that contact a test pad of the display panel 20. The COG resistance measuring unit 70C includes a power source 91, a switch 93, a comparison unit (e.g., comparator) 95, a counter 97, a register 99, and a capacitor C.

The power source 91 is connected to a first bump of the pair of bumps, so that the power source 91 is connected in series with the first resistor R1 that is formed by connection between the first bump and the test pad. The second resistor R2 that is connected in series with the first resistor R1 is formed when a second bump of the pair of bumps is connected with the test pad. The power source 91 provides a power voltage V_{IC}, thereby allowing a current to flow through the first resistor R1 and the second resistor R2. The power source 91 may be an internal power source (or internal voltage) of the driving IC.

The switch 93 selectively connects and disconnects the power source 91 to and from the first bump.

The comparison unit 95 measures a voltage V_{N} at a measurement node N, that is a node between the second resistor R2 and the capacitor C, and compares the voltage V_{N} with a target voltage V_{TAR}.

The counter 97 is activated by a start signal S, counts a time taken for the voltage V_{N} at the measurement node N to reach the target voltage V_{TAR} by using a clock signal CLOCK, and converts a count value into a digital value. It is possible to check a delay time of the voltage V_{N} at the measurement node N by using the count value. The delay time of the voltage V_{N} at the measurement node N varies according to the COG resistance R_{COG}.

FIG. 12 is a graph showing a delay of the voltage V_{N} at the measurement node N according to the COG resistance R_{COG}. Referring to FIG. 12, when the COG resistance R_{COG} is small, a delay time t1 taken for the voltage V_{N} at the measurement node N to reach the target voltage V_{TAR} is shorter than a delay time t2 taken for the voltage V_{N} at the measurement node N to reach the target voltage V_{TAR} when the COG resistance R_{COG} is great. That is, it is possible to see that a delay time taken for the voltage V_{N} at the measurement node N to reach the target voltage V_{TAR} is shorter when the COG resistance R_{COG} is smaller.

The register 99 stores the count value received from the counter 97. The stored count value is read by an external controller via an IC interface and is displayed on a monitor. The IC interface may include a CPU interface, a serial interface or the like.

One end of the capacitor C is connected to the second bump and the other end is connected to a ground terminal. The capacitor C is connected to the second bump, so that the capacitor C is serially connected to the first resistor R1 and the second resistor R2 that are the COG resistance R_{COG}. The capacitor C may be formed in the driving IC, or the capacitor C may be formed on the display panel 20 outside the driving IC.

The COG resistance R_{COG} may be in accordance with Equation 2 by using Equation 3 after obtaining a delay time T of the voltage V_{N} at the measurement node N. Here, a is a coefficient, the power voltage V_{IC} and the amount of the capacitor C are constant values, and levels of the first resistor R1 and the second resistor R2 are the same.

T=a×(R1+R2)×C Equation 3

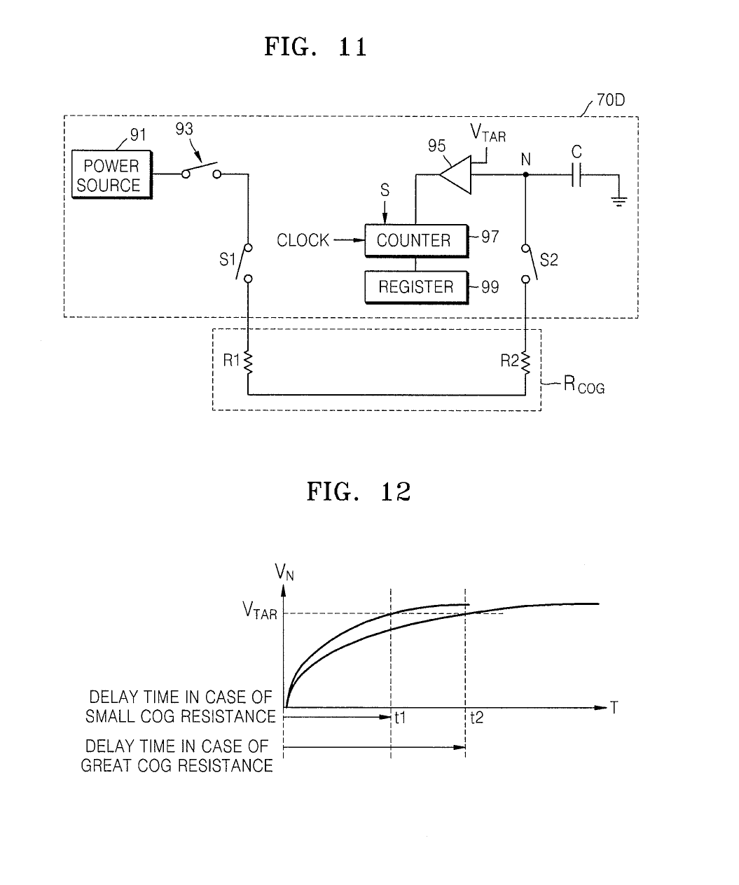

FIG. 11 illustrates a circuit configuration of a COG resistance measuring unit 70D in a driving IC, according to another embodiment of the present invention.

The embodiment of FIG. 11 is different from the embodiment of FIG. 10 in that a first switch S1 is arranged between a power source 91 and a first resistor R1, and a second switch S2 is arranged between a second resistor R2 and a capacitor C. Except for these differences, other components of the embodiment of FIG. 11 are the same as those of the embodiment of FIG. 10, thus, detailed descriptions thereof are omitted here.

In the embodiment of FIG. 10, the COG resistance measuring unit 70C is arranged in the driving IC at every test point. However, in the embodiment of FIG. 11, only one COG resistance measuring unit 70D is arranged in the driving IC. That is, the COG resistance measuring unit 70C of FIG. 11 may time-divisionally measure COG resistances R_{COG} at a plurality of test points by using the first switch S1 and the second switch S2 (e.g., a plurality of first switches S1 and a plurality of second switches S2 arranged to selectively couple a pair of bumps and test pads to the COG resistance measuring unit 70D).

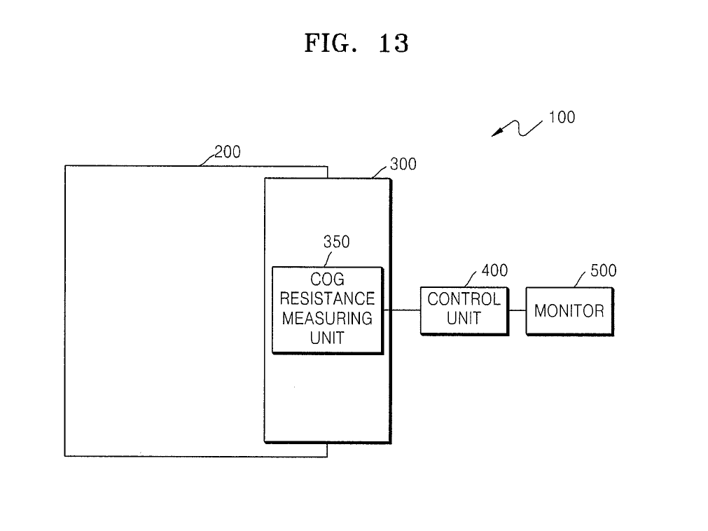

FIG. 13 is a diagram of a COG resistance automatic measurement system, according to an embodiment of the present invention.

Referring to FIG. 13, according to one embodiment of the present invention, the COG resistance measurement system 350 is included in a display apparatus 100 including a display panel 200 and a driving IC 300 electrically connected to the display panel 200, a control unit 400 reading data for COG resistance measurement from the driving IC 300, and a monitor 500 displaying measurement data and a calculation result.

The display panel 200 has a plurality of signal pads and at least one test pad formed in at least one side of the display panel 200.

The driving IC 300 drives the display panel 200 and may be formed by integrating a plurality of circuits for driving the display panel 200. The driving IC 300 may receive an external voltage from an external source and may generate an internal voltage to be used in the driving IC 300. The driving IC 300 may be mounted on the display panel 200 by performing a COG method. The driving IC 300 has at least one pair of bumps electrically connected to the at least one test pad, and at least one COG resistance measuring unit 350 connected to the at least one pair of bumps so as to automatically measure connection resistance due to COG connection.

The COG resistance measuring unit 350 may be formed at every test point of the driving IC 300, or may be singularly formed and time-divisionally connected to a plurality of test points by using a switch (or a plurality of switches). The COG resistance measuring unit 350 includes a power source connected to a first bump of the at least one pair of bumps, a circuit device connected between a ground terminal and a second bump of the at least one pair of bumps, and a node measuring unit measuring a voltage at a node between the circuit device and the second bump. Here, the circuit device may be a resistor or a capacitor. A configuration of the COG resistance measuring unit 350 is described above with reference to FIGS. 8, 9, 10, and 11.

The control unit 400 may read a voltage value or a count value via an IC interface, which is a measurement result from the COG resistance measuring unit 350, and makes the voltage value or the count value displayed on the monitor 500. An inspector may immediately check the value displayed on the monitor 500 and may separately store the value.

According to the one or more embodiments, a COG resistance may be automatically measured without performing a manual operation, and if necessary, a measurement point may be added easily. Also, it is not necessary to form a measurement pad in an FPC so that flexibility with respect to an FPC design may be enhanced.

Furthermore, in the mass production of a display panel, whether a COG resistance is increased may be monitored in advance, so that it is possible to sort out good products.

While the present invention has been particularly shown and described with reference to exemplary embodiments thereof, it will be understood by those of ordinary skill in the art that various changes in form and details may be made therein without departing from the spirit and scope of the present invention as defined by the following claims and equivalents thereof.

What is claimed is:

1. A driving integrated circuit (driving IC) coupled to a display panel by a chip on glass (COG) method, the driving IC comprising:
a pair of bumps electrically coupled to a test pad of the display panel;
a power source electrically coupled to a first bump of the pair of bumps;
a circuit device electrically coupled between a ground terminal and a second bump of the pair of bumps; and
a node measuring unit for measuring a voltage at a node between the second bump and the circuit device.

2. The driving IC of claim 1, wherein the circuit device comprises a resistor.

3. The driving IC of claim 2, wherein the node measuring unit comprises an analog-to-digital (A/D) converter for measuring the voltage at the node and for converting the voltage into a digital value.

4. The driving IC of claim 1, wherein the circuit device comprises a capacitor.

5. The driving IC of claim 4, wherein the node measuring unit comprises:
a comparison unit for comparing the voltage at the node with a target voltage; and
a counter for counting a time elapsed for the voltage at the node to reach the target voltage.

6. The driving IC of claim 1, further comprising a register for storing the voltage.

7. The driving IC of claim 1, wherein the power source is electrically coupled to the first bump via a switch.

8. The driving IC of claim 1, wherein the power source is an internal voltage of the driving IC.

9. The driving IC of claim 1, further comprising:
a first switch electrically coupled between the power source and the first bump and
a second switch electrically coupled between the second bump and the circuit device,
wherein the first switch and the second switch are configured to time-divisionally electrically couple one or more pairs of bumps to one or more respective test pads.

10. A display apparatus comprising:
a display panel comprising a test pad; and
a driving integrated circuit (driving IC) coupled to the display panel by a chip on glass (COG) method, configured to automatically measure a connection resistance due to the COG connection, and comprising:
a pair of bumps electrically coupled to the test pad;
a power source electrically coupled to a first bump of the pair of bumps;
a circuit device electrically coupled between a ground terminal and a second bump of the pair of bumps; and
a node measuring unit for measuring a voltage at a node between the second bump and the circuit device.

11. The display apparatus of claim 10, wherein the circuit device comprises a resistor.

12. The display apparatus of claim 11, wherein the node measuring unit comprises an analog-to-digital (ND) converter for measuring the voltage at the node and for converting the voltage into a digital value.

13. The display apparatus of claim 10, wherein the circuit device comprises a capacitor.

14. The display apparatus of claim 13, wherein the node measuring unit comprises:
a comparison unit for comparing the voltage at the node with a target voltage; and
a counter for counting a time elapsed for the voltage at the node to reach the target voltage.

15. The display apparatus of claim 10, wherein the driving IC further comprises a register for storing the voltage.

16. The display apparatus of claim 10, wherein the power source is electrically coupled to the first bump via a switch.

17. The display apparatus of claim 10, wherein the power source is an internal voltage of the driving IC.

18. The display apparatus of claim 10, wherein the circuit device is arranged in the driving IC.

19. The display apparatus of claim 10, wherein the circuit device is arranged on the display panel outside the driving IC.

20. The display apparatus of claim 10, wherein the driving IC further comprises:
a first switch between the power source and the first bump and
a second switch between the second bump and the circuit device,
wherein the first switch and the second switch are configured to time-divisionally electrically couple one or more pairs of bumps to one or more respective test pads.
